(19) United States
(12) Patent Application Publication
(10) Pub. No.: US 2010/0019079 A1
(43) Pub. Date: Jan. 28, 2010

(54) THRUST GENERATOR FOR A ROTARY WING AIRCRAFT

(75) Inventors: Andrei Tristan Evulet, Clifton Park, NY (US); Sanjay Marc Correa, Niskayuna, NY (US); Ludwig Christian Haber, Rensselaer, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/765,695

(22) Filed: Jun. 20, 2007

(51) Int. Cl. B64C 27/82

(52) U.S. Cl. 244/17.19

(57) ABSTRACT

A thrust generator is provided. The thrust generator is configured to introduce a motive fluid along a Coanda profile and to entrain additional fluid to create a high velocity fluid flow, wherein the high velocity fluid flow is configured to generate thrust for counter-acting a torque generated by a rotating component.

### BACKGROUND

The invention relates generally to rotary wing aircrafts, and more particularly, to a thrust generator for a rotary wing aircraft.

Various types of rotary wing aircrafts are known and are in use. Typically, a rotary wing aircraft such as a helicopter is lifted and propelled using one or more horizontal rotors having two or more rotor blades. The rotor provides the lift to the helicopter in a vertical direction to facilitate vertical take off and landing and to maintain a steady hover in the air. However, turning the rotor also applies a reverse torque that would spin the helicopter fuselage in an opposite direction relative to the rotor.

A small vertical propeller or a tail rotor is generally employed to counteract the torque generated by the rotor. The tail rotor is mounted at the rear of the helicopter and creates a thrust that is in opposite direction relative to the torque generated by the main rotor. However, the amount of engine power required to run the tail rotor is significant and such power from the engine does not help the helicopter to produce lift or forward motion. Further, the tail rotor requires moving parts and is susceptible to damage due to foreign object debris (FOD).

Certain rotary wing aircraft employ two main rotors that turn in opposite directions so that the torque from each rotor cancels out without causing the spinning of the helicopter fuselage. Unfortunately, this technique causes mechanical complexity to the design of the rotary wing aircraft and is usually relegated to specialized helicopter types.

Accordingly, there is a need for a device that can address counter-torque needs of rotary wing aircraft. Furthermore, it would be desirable to provide a device that can be integrated with existing rotary wing aircrafts, provides better maneuverability of the aircraft and has low cost of operation.

### BRIEF DESCRIPTION

Briefly, according to one embodiment a thrust generator is provided. The thrust generator is configured to introduce a motive fluid along a Coanda profile and to entrain additional fluid to create a high velocity fluid flow, wherein the high velocity fluid flow is configured to generate thrust for counter-acting a torque generated by a rotating component.

In another embodiment, a rotary wing aircraft is provided. The rotary wing aircraft includes a rotor configured to generate lift for driving the rotary wing aircraft and an engine configured to drive the rotor. The rotary wing aircraft also includes a plurality of thrust generators configured to receive compressor bleed air, or an exhaust gas from the engine and to generate a thrust for counter-acting a torque generated by the rotor through a high velocity airflow. Each of the thrust generators includes at least one surface of the thrust generator having a Coanda profile configured to facilitate attachment of the compressor bleed air, or the exhaust gas to the profile to form a boundary layer and to entrain incoming air to generate the high velocity airflow.

In another embodiment, a rotary wing aircraft is provided. The rotary wing aircraft includes a rotor configured to generate lift for driving the rotary wing aircraft and a tail rotor configured to generate thrust for counter-acting a torque generated by the rotor. The rotary wing aircraft also includes a plurality of thrust generators configured to receive compressor bleed air, or an exhaust gas from an engine of the rotary wing aircraft and to generate thrust for counter-acting the torque generated by the rotor through a high velocity airflow. Each of the thrust generators includes at least one surface of the thrust generator having a Coanda profile configured to facilitate attachment of the compressor bleed air, or the exhaust gas to the profile to form a boundary layer and to entrain incoming air to generate the high velocity airflow.

In another embodiment, a method for counter-acting a torque generated by a rotating component of a rotary wing aircraft is provided. The method includes coupling at least one thrust generator to the aircraft, wherein the at least one thrust generator is configured to generate a thrust by bypassing compressor bleed air, or an exhaust gas from an engine of the rotary wing aircraft over a Coanda profile to form a boundary layer and subsequently entrain incoming air through the boundary layer; wherein the generated thrust is such that its resulting torque is in a direction that is substantially opposite to a direction of the torque generated by the rotating component.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of rotary wing aircraft having a plurality of thrust generators in accordance with aspects of the present technique.

FIG. 2 is a diagrammatical illustration of an exemplary configuration of an engine of the rotary wing aircraft of FIG. 1 in accordance with aspects of the present technique.

FIG. 3 is a diagrammatical illustration of an exemplary configuration of rotary wing aircraft having a thrust generator disposed adjacent to a tail boom of the rotary wing aircraft in accordance with aspects of the present technique.

FIG. 4 is a diagrammatical illustration of another exemplary configuration of rotary wing aircraft having a plurality of thrust generators and a tail rotor in accordance with aspects of the present technique.

FIG. 5 is a diagrammatical illustration of an exemplary configuration of the thrust generator of FIG. 1 in accordance with aspects of the present technique.

FIG. 6 is a diagrammatical illustration of flow profiles of air and compressor bleed air or exhaust gas within the thrust generator of FIG. 5 in accordance with aspects of the present technique.

FIG. 7 is a diagrammatical illustration of the formation of boundary layer adjacent a Coanda profile in the thrust generator of FIG. 5 in accordance with aspects of the present technique.

### DETAILED DESCRIPTION

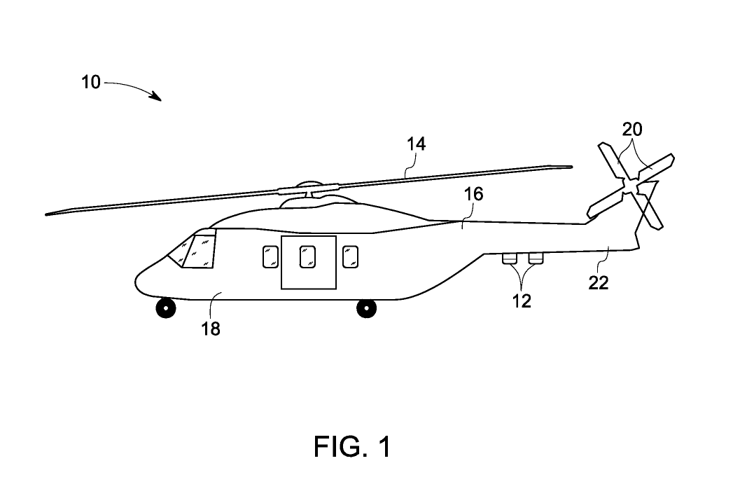

As discussed in detail below, embodiments of the present technique function to provide a device for counter-acting torque generated by a rotating component such as a rotor of a rotary wing aircraft. In particular, the present technique utilizes the combination of a motive fluid and ambient air to generate thrust for counter-acting the torque generated by the rotor. Turning now to the drawings and referring first to FIG. 1 a rotary wing aircraft, or a helicopter 10 having a plurality of thrust generators such as represented by reference numeral 12 is illustrated. The aircraft 10 includes a rotor 14 configured to generate lift for driving the helicopter 10. The rotor 14 is driven by an engine (not shown), which is mounted on an engine mount (not shown) on a body 16 of the helicopter 10.

Turning the rotor 14 generates the lift for driving the aircraft 10. In addition, the rotor 14 also applies a reverse torque that spins helicopter fuselage 18 in an opposite direction relative to a direction of rotation of the rotor 14. In certain embodiments, a tail rotor 20 is mounted at the rear of the helicopter 10 for counter-acting the torque generated by the rotor 14. In the illustrated embodiment, the plurality of thrust generators 12 are configured to receive a compressor bleed air or an exhaust gas from the engine and to generate a thrust for counter-acting the torque generated by the rotor 14. In the illustrated embodiment, the helicopter 10 includes two thrust generators 12 disposed adjacent to a tail boom 22 of the helicopter. However, a greater or lesser number of the thrust generators 12 may be employed for generating the thrust. Further, the thrust generators may be disposed on the body 16 of the helicopter 10. In one exemplary the thrust generators 12 may replace the tail rotor 20 of the helicopter 10. The thrust generators 12 are configured to generate the thrust for counter-acting the torque through a high velocity flow that will be described in detail below.

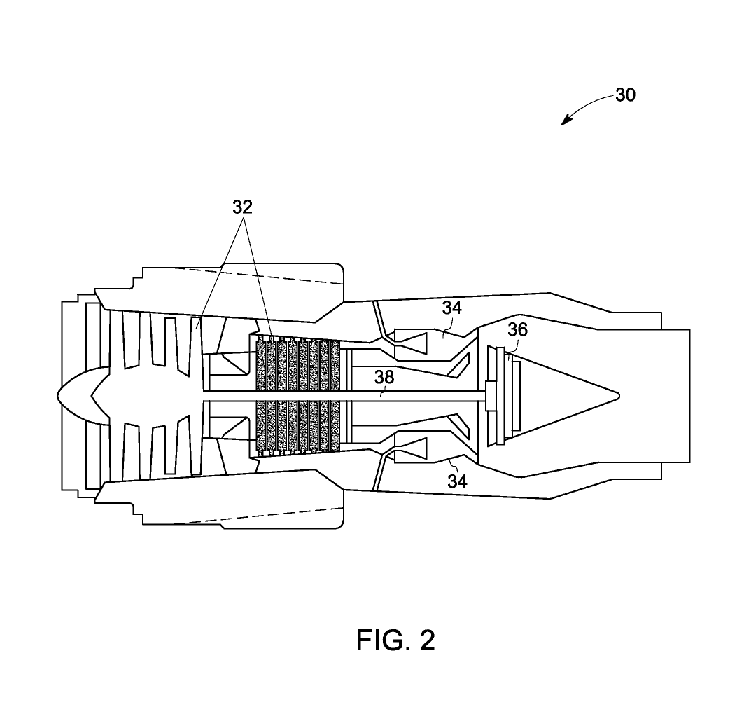

FIG. 2 is a diagrammatical illustration of an exemplary configuration 30 of an engine of the helicopter 10 of FIG. 1. The engine 30 includes a compressor 32 configured to compress ambient air. A combustor 34 is in flow communication with the compressor 32 and is configured to receive compressed air from the compressor 32 and to combust a fuel stream to generate a combustor exit gas stream. In addition, the engine 30 includes a turbine 36 located downstream of the combustor 34. The turbine 36 is configured to expand the combustor exit gas stream to drive an external load. In the illustrated embodiment, the compressor 32 is driven by the power generated by the turbine 36 via a shaft 38. Further, an engine drive shaft (not shown) is coupled through a transmission to a rotor shaft (not shown) for driving the rotor 14 (see FIG. 1). In addition, a portion of the engine power is utilized for driving the tail rotor 20 (see FIG. 1) of the helicopter 10.

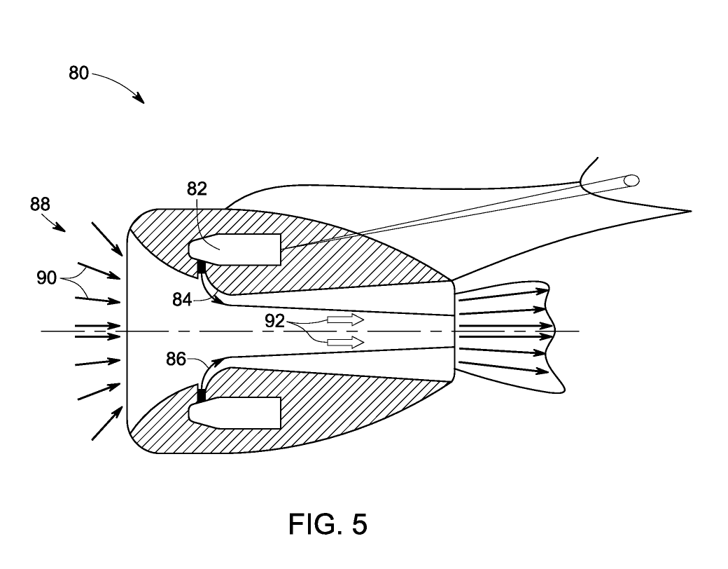

In this exemplary embodiment, compressor bleed air from the compressor 32 is directed to the thrust generators 12 (see FIG. 1). In certain other embodiments, exhaust gas generated through combustion of the fuel stream and air in the combustor 34 is directed to the thrust generators 12. The thrust generators 12 are configured to form a boundary layer and to entrain additional airflow via the compressor bleed air or the exhaust gas to generate thrust through a high velocity airflow. In particular, the entrained air forms a shear layer with the boundary layer to accelerate the air at a converging section of the thrust generator 12 and to facilitate mixing of the boundary layer and the incoming air to generate the high velocity airflow at a downstream section of the thrust generator 12. Furthermore, the downstream section of the thrust generator 12 generates the thrust for counter-acting the torque generated by the rotor 14 from pressure forces resulting from the interaction between the compressor bleed air or the exhaust gas and the entrained air. The operation of the thrust generator 12 will be described in detail below with reference to FIGS. 5-7.

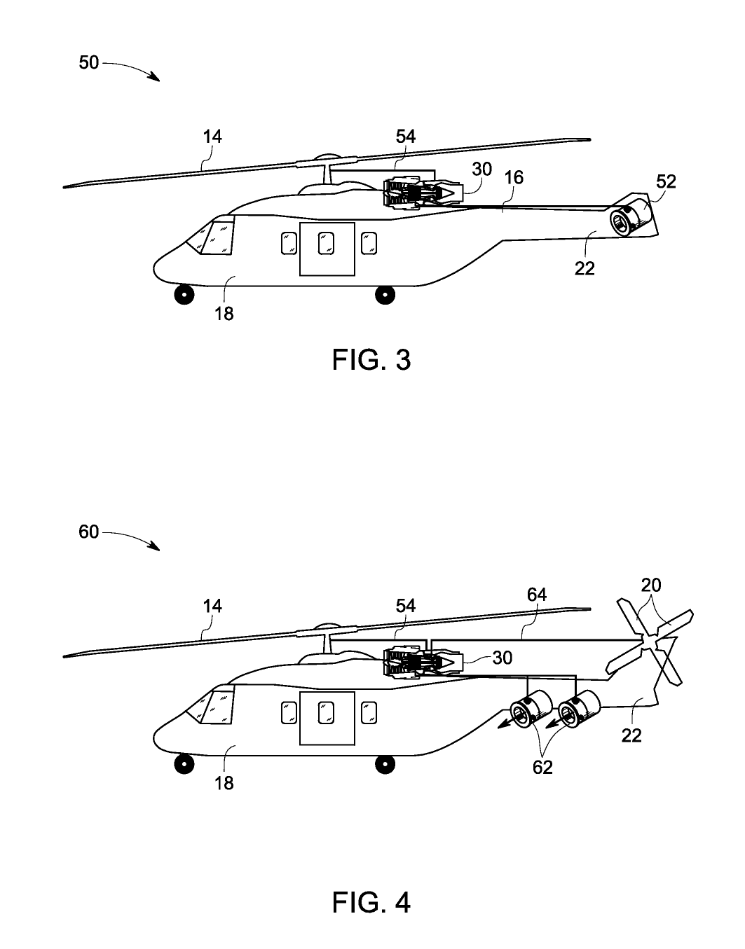

FIG. 3 is a diagrammatical illustration of an exemplary configuration 50 of rotary wing aircraft having a thrust generator 52 disposed adjacent to the tail boom 22 of the rotary wing aircraft 50 in accordance with aspects of the present technique. In this exemplary embodiment, the engine 30 is configured to drive the rotor 14 through a drive shaft 54. Further, the compressor bleed air and/or the exhaust gas from the engine 30 is directed to the thrust generator 52 disposed at the rear of the rotary wing aircraft 50. The thrust generator 52 is configured to generate the thrust for counter-acting torque generated by the rotor 14. In particular, the thrust generator 52 generates a thrust that produces a torques, which is in a substantially opposite direction relative to that of the torque generated by the rotor 14. In this exemplary embodiment, at least one surface of the thrust generator 52 includes a Coanda profile that is configured to facilitate attachment of the compressor bleed air or the exhaust gas to the profile and to entrain incoming air to generate a high velocity flow. It should be noted that the turning of the boundary layer around the Coanda profile induces a radial pressure gradient that enhances the entrainment of air thereby enhancing the efficiency of such thrust generator 52. As used herein, the term “Coanda profile” refers to a profile that is configured to facilitate attachment of a stream of fluid to a nearby surface and to remain attached even when the surface curves away from the original direction of fluid motion. In one embodiment, the Coanda profile includes a logarithmic profile.

As illustrated, the rotary aircraft 50 includes a thrust generator 52 disposed adjacent to the tail boom 22 of the aircraft 50. However, a greater or lesser number of thrust generators 52 may be coupled to the aircraft 50 for generating a required thrust for counter-acting the torque generated by the rotor 14. Further, in certain embodiments, the thrust generators 52 may be disposed on the body 16 of the aircraft 52. In certain other embodiments, the thrust generators 52 may be disposed in a nose of the aircraft 52. The thrust generated by the thrust generators 52 may be controlled by adjusting a compressor bleed airflow, or a rotation of the thrust generators 52, or a number of the thrust generators 52, or a location of the thrust generators 52, or combinations thereof. Further, since the thrust generator 52 has multiple degrees of freedom, the thrust generator 52 may be employed to adjust an attitude of the aircraft 50 in flight or during hovering of the aircraft 50. In particular, a plurality of thrust generators 52 may be employed to facilitate the aircraft 50 to hover back and forth, pitch, yaw and roll without changing main rotor settings of the aircraft 50.

FIG. 4 is a diagrammatical illustration of another exemplary configuration 60 of a rotary wing aircraft having a plurality of thrust generators 62 and the tail rotor 20 in accordance with aspects of the present technique. In this exemplary embodiment, the rotor 14 is driven by the engine 30 through the drive shaft 54. In addition, a portion of the engine power is utilized to drive the tail rotor 20 through a drive shaft 64. The tail rotor 20 is configured to generate thrust for counter-acting the torque generated by the rotor 14. In certain embodiments, if the tail rotor 20 fails, the thrust generators 62 are utilized to generate the thrust for counter-acting the torque generated by the rotor 14 thereby facilitating a safe landing of the aircraft 60. In certain embodiments, a portion of the thrust required for counter-acting the torque generated by the rotor 14 is generated by the tail rotor 20 while the rest of the thrust is generated by the thrust generators 62 thereby saving engine power. A controller (not shown) may be coupled to the thrust generators 62 and to the tail rotor 20 for controlling the operation of the thrust generators 62 and the tail rotor for counter-acting the torque generated by the rotor 14. As illustrated, the aircraft 60 includes two thrust generators 62 disposed adjacent the tail boom 22 for generating the thrust. Again, a greater or lesser number of the thrust generators 62 may be employed for generating a desired thrust.

As described earlier with reference to FIG. 1, the thrust generator 12 is configured to generate the thrust for counter-acting the torque through a high velocity flow. In particular, the thrust generator is configured to introduce a motive fluid such as compressor bleed air or exhaust gas along a Coanda profile and to entrain airflow to create the high velocity fluid flow for generating the thrust.

FIG. 5 is a diagrammatical illustration of an exemplary configuration 80 of the thrust generator 12 of FIG. 1 in accordance with aspects of the present technique. The thrust generator 80 receives compressor bleed air or exhaust gas from the engine 30 (see FIG. 2) of the aircraft 10. In certain embodiments, the thrust generator 80 includes a plenum 82 that is configured to receive the exhaust gas from the engine 30. The compressor bleed air or the exhaust gas from the engine 30 is deflected over a Coanda profile 84 that is configured to facilitate attachment of the compressor bleed air or the exhaust gas to the profile 84. In this exemplary embodiment, the plenum 82 is annular around a cowl of the thrust generator 80. Further, a plurality of slots (not shown) may be employed to introduce the compressor bleed air or exhaust gas from the plenum 82 over the Coanda profile 84. In one exemplary embodiment, the Coanda profile 84 includes a logarithmic profile. In operation, the compressor bleed air or the exhaust gas from the plenum 82 is introduced along the Coanda profile 84 as represented by reference numeral 86. Further, the thrust generator 80 includes an air inlet 88 for introducing airflow 90 within the thrust generator 80.

During operation, the compressor bleed airflow or the pressurized exhaust gas 86 entrains airflow 90 to generate a high velocity airflow 92. In particular, the Coanda profile 84 facilitates relatively fast mixing of the compressor bleed airflow or the exhaust gas 76 with the entrained airflow 90 and generates the high velocity airflow 92 by transferring the energy from the compressor bleed airflow or the exhaust gas 86 to the airflow 80. Further, the turning of the compressor bleed airflow or the exhaust gas 86 around the Coanda profile 84 induces a radial pressure gradient that enhances the entrainment of air 90 thereby enhancing the efficiency of such thrust generator 80. In this exemplary embodiment, the Coanda profile 84 facilitates attachment of the compressor bleed airflow or the pressurized exhaust gas 86 to the profile 84 until a point where the velocity of the flow drops to a fraction of the initial velocity while imparting momentum to the airflow 90. It should be noted that the design of the thrust generator 80 is selected such that it enhances the acceleration of incoming airflow 90 that flows from an ambient condition to the outlet of the thrust generator 80 thereby maximizing the thrust generated from the thrust generator 80. Further, the high velocity airflow 90 may be utilized to generate thrust for counter-acting the torque generated by the rotor 14.

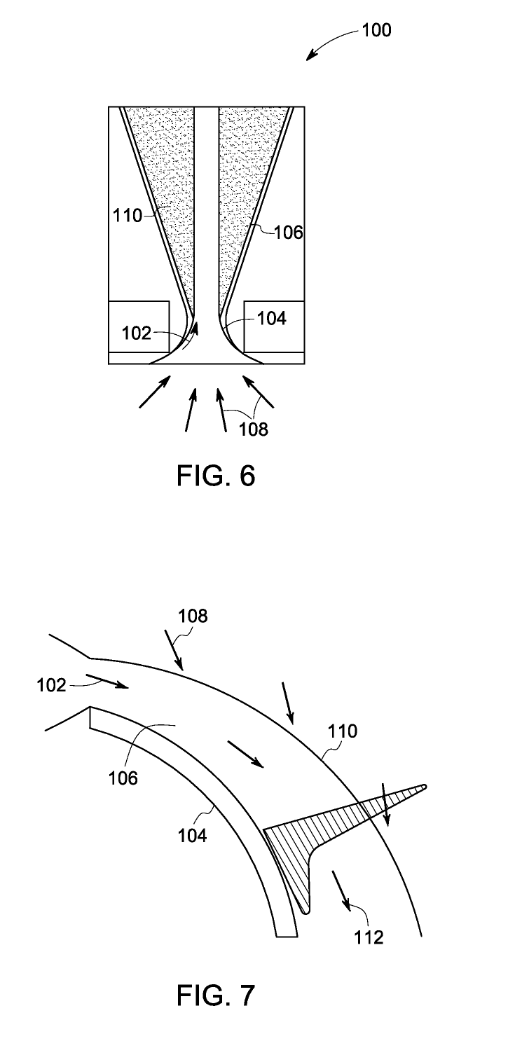

The Coanda profile 84 facilitates attachment of the compressor bleed air or the exhaust gas to the profile 84 to form a boundary layer and entrains incoming airflow 90 to generate the high velocity airflow 92. In the illustrated embodiment, the air supplied 90 through the air inlet 88 forms a shear layer with the boundary layer to accelerate the airflow 90 at a converging section of the thrust generator 80 and to facilitate mixing of the boundary layer and the incoming airflow 90 to generate the high velocity airflow 92 at a section of the thrust generator 80. The formation of the boundary and shear layers for generating the high velocity airflow 92 will be described in detail below with reference to FIGS. 6-7.

FIG. 6 is a diagrammatical illustration of flow profiles 100 of air and compressor bleed air or exhaust gas within the thrust generator 80 of FIG. 5 in accordance with aspects of the present technique. As illustrated, the compressor bleed air or exhaust gas 102 from the engine 30 (see FIG. 2) is directed inside the thrust generator 80 and over a Coanda profile 104. In the illustrated embodiment, the compressor bleed air or the exhaust gas 102 is introduced into the thrust generator 80 at a substantially high velocity and pressure. In operation, the Coanda profile 104 facilitates attachment of the compressor bleed air or the exhaust gas 102 with the profile 104 to form a boundary layer 106. In this embodiment, the geometry and the dimensions of the profile 104 are optimized to achieve a desired thrust. Further, a flow of incoming air 108 is entrained by the boundary layer 106 to form a shear layer 110 with the boundary layer 106 for promoting the mixing of the incoming air 108 and the compressor bleed air or the exhaust gas 102. It should be noted that the mixing of the airflow 108 and the compressor bleed air or the exhaust gas 102 is enhanced due to the growth without separation of the boundary layer 106 downstream of the location of its introduction due to a negative pressure gradient. In certain embodiments, introduction of the motive fluid from independent openings further enhances mixing and entrainment between consecutive motive introduction slots. The attachment of the compressor bleed air or the exhaust gas 102 to the Coanda profile 104 due to the Coanda effect in the thrust generator 80 will be described in detail below with reference to FIG. 8.

FIG. 7 is a diagrammatical illustration of the formation of boundary layer 106 adjacent the profile 104 in the thrust generator 80 of FIG. 5 based upon the Coanda effect. In the illustrated embodiment, the compressor bleed air or the exhaust gas 102 attaches to the profile 104 and remains attached even when the surface of the profile 104 curves away from the initial flow direction. More specifically, as the compressor bleed air or the exhaust gas 102 flows along the profile 104 and detaches from the profile 104, a low pressure region is generated near the profile 104 keeping the flow 102 attached to the profile 104. As the flow 102 remains attached to the curving wall of the profile 104, a pressure gradient is generated, which induces ambient air 108 to flow into the thrust generator 80. Furthermore, the high velocity surface flow along the profile 104 generates a shear layer 110 which further helps transfer of energy from the compressor bleed air or the exhaust gas 102 to the entrained air 108. Thus, injection of compressor bleed air or the exhaust gas 102 across a profile 104 designed to facilitate the Coanda effect determines first a large entrainment ratio of the airflow 108 to the motive fluid such as compressor bleed air or exhaust gas 102 and generates a driving force that causes air 108 to accelerate. Furthermore, the shear layer 110 formed by the motive fluid and the entrained air 108 generates a high velocity airflow 112 that is utilized for generating thrust for counter-acting the torque generated by the rotor 14 (see FIG. 1).

The various aspects of the method described hereinabove have utility in addressing counter-torque needs of rotary wing aircrafts. The technique described above employs a thrust generator that can be integrated with existing rotary wing aircrafts and utilizes a driving fluid such as compressor bleed air or exhaust gases from an engine of the rotary wing aircraft to entrain a secondary fluid flow for generating a high velocity airflow. In particular, the thrust generator employs the Coanda effect to generate the high velocity airflow that may be further used for generating thrust and consequently a torque in a substantially opposite direction relative to the torque generated by a main rotor of the rotary aircraft.

Advantageously, the thrust generation using such thrust generators eliminates the need of moving parts such as a tail rotor in existing rotary aircrafts thereby substantially reducing cost of operation of such aircrafts. Further, if the tail rotor of the rotary aircraft fails, the thrust generators may be used as an emergency system to provide the thrust for counter-acting the torque generated by the main rotor thereby facilitating emergency landing of the aircraft. The thrust generator described above also facilitates better maneuverability of the aircraft and facilitates easy maintenance by eliminating moving parts such as the tail rotor and tail rotor driving shaft.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A thrust generator configured to introduce a motive fluid along a Coanda profile and to entrain additional fluid to create a high velocity fluid flow, wherein the high velocity fluid flow is configured to generate thrust for counter-acting a torque generated by a rotating component.

2. The thrust generator of claim 1, wherein the rotating component comprises a rotor of a rotary wing aircraft.

3. The thrust generator of claim 2, wherein the thrust generator is disposed adjacent to a tail boom of the rotary wing aircraft.

4. The thrust generator of claim 2, wherein the motive fluid comprises compressor bleed air or an exhaust gas from an engine of the rotary wing aircraft and the additional fluid comprises air surrounding the thrust generator.

5. The thrust generator of claim 4, wherein the Coanda profile facilitates attachment of the compressor bleed air, or the exhaust gas to the profile to form a boundary layer configured to entrain incoming air to generate high velocity airflow.

6. The thrust generator of claim 5, wherein the incoming air forms a shear layer at the boundary layer to accelerate the air at a converging section of the thrust generator to generate the high velocity airflow at a downstream section of the thrust generator.

7. The thrust generator of claim 6, wherein the downstream section of the device generates the thrust from a momentum difference between inlet and exit flows from the thrust generator.

8. The thrust generator of claim 1, wherein the Coanda profile comprises a logarithmic profile.

9. A rotary wing aircraft, comprising:
a rotor configured to generate lift for driving the rotary wing aircraft;
an engine configured to drive the rotor; and
a plurality of thrust generators configured to receive a compressor bleed air, or an exhaust gas from the engine and to generate a thrust for counter-acting a torque generated by the rotor through a high velocity airflow; wherein each of the thrust generators comprises:
at least one surface of the thrust generator having a Coanda profile configured to facilitate attachment of the compressor bleed air, or the exhaust gas to the profile to form a boundary layer and to entrain incoming air to generate the high velocity airflow.

10. The rotary wing aircraft of claim 9, wherein the thrust generators are disposed on a body, or adjacent to a tail boom of the rotary wing aircraft.

11. The rotary wing aircraft of claim 9, wherein the thrust generated by the thrust generator is controlled by adjusting a compressor bleed airflow, or a rotation of the thrust generator, or combinations thereof.

12. The rotary wing aircraft of claim 9, wherein the Coanda profile comprises a logarithmic profile.

13. The rotary wing aircraft of claim 9, wherein the incoming air forms a shear layer at the boundary layer to accelerate the air at a converging section of the thrust generator to generate the high velocity airflow at a downstream section of the thrust generator

14. The rotary wing aircraft of claim 9, wherein the thrust generated by the thrust generator is in a substantially opposite direction relative to that of the torque generated by the rotor.

15. The rotary wing aircraft of claim 9, wherein the thrust generator is configured to adjust an attitude of the rotary wing aircraft.

16. A rotary wing aircraft; comprising:
a rotor configured to generate lift for driving the rotary wing aircraft;
a tail rotor configured to generate thrust for counter-acting a torque generated by the rotor; and
a plurality of thrust generators configured to receive compressor bleed air, or an exhaust gas from an engine of the rotary wing aircraft and to generate thrust for counter-acting the torque generated by the rotor through a high velocity airflow; wherein each of the thrust generators comprises:
at least one surface of the thrust generator having a Coanda profile configured to facilitate attachment of the compressor bleed air, or the exhaust gas to the profile to form a boundary layer and to entrain incoming air to generate the high velocity airflow.

17. The rotary wing aircraft of claim 16, further comprising a controller coupled to the thrust generators and the tail rotor and configured to control operation of the thrust generators and the tail rotor for counter-acting the torque generated by the rotor.

18. The rotary wing aircraft of claim 16, wherein the tail rotor includes a vertical propeller positioned on a tail boom of the rotary wing aircraft.

19. The rotary wing aircraft of claim 16, wherein the thrust generators are disposed on a body, or adjacent to the tail boom of the rotary wing aircraft.

20. The rotary wing aircraft of claim 16, wherein the Coanda profile comprises a logarithmic profile.

21. A method for counter-acting a torque generated by a rotating component of a rotary wing aircraft, comprising:
coupling at least one thrust generator to the aircraft, wherein the at least one thrust generator is configured to generate a thrust by bypassing compressor bleed air, or an exhaust gas from an engine of the rotary wing aircraft over a Coanda profile to form a boundary layer and subsequently entrain incoming air through the boundary layer; wherein the generated thrust is such that its resulting torque is in a direction that is substantially opposite to a direction of the torque generated by the rotating component.

22. The method of claim 21, further comprising forming a shear layer of the entrained air with the boundary layer to accelerate the air at a converging section of the thrust generator to generate high velocity airflow at a section of the thrust generator.

23. The method of claim 20, wherein the rotating component comprises a rotor configured to generate lift for driving the rotary wing aircraft.

24. The method of claim 20, further comprising adjusting a compressor bleed airflow, or a rotation of the thrust generator, or combinations thereof to generate a desired thrust for counteracting the torque.
